(19) United States
(12) Patent Application Publication
(10) Pub. No.: US 2014/0152107 A1
(43) Pub. Date: Jun. 5, 2014

(54) PHOTOVOLTAIC POWER GENERATION SYSTEM

(71) Applicant: Ryuichi Shimada, Meguro-Ku (JP)

(72) Inventor: Ryuichi Shimada, Meguro-Ku (JP)

(73) Assignee: TOKYO INSTITUTE OF TECHNOLOGY, Meguro-Ku, Tokyo (JP)

(21) Appl. No.: 14/235,286

(22) PCT Filed: Aug. 1, 2012
(86) PCT No.: PCT/JP2012/069574

§ 371 Date: Feb. 11, 2014

(30) Foreign Application Priority Data
Aug. 1, 2011 (JP) 2011-168343

(51) Int. Cl. H02J 1/12

(52) U.S. Cl. CPC H02J 1/12
USPC 307/52

(57) ABSTRACT

[Problem]

An object of the present invention is to provide a photovoltaic power generation system that performs the MPPT control with respect to respective panels and minimizes the power loss due to the power conversion.

[Means for Solving the Problem]

The photovoltaic power generation system according to the present invention performs an MPPT control for each photovoltaic panel by charging the lacking voltage or current. The power charge section connected in series or parallel to each panel charges the lacking voltage or current being caused by the non-uniformity of light quantities of the photovoltaic panels or temperatures.

### TECHNICAL FIELD

The present invention relates to a photovoltaic power generation system (solar photovoltaic(PV) system) for converting into an alternate current (AC) by a PWM (Pulse Width Modulation) converter or the like in order to perform an efficient charging from a photovoltaic cell (solar cell) to a secondary cell and an interactive operation to a power system, and in particular to the photovoltaic power generation system has a maximum power point tracking (MPPT) function for controlling in such a way as to allow for taking out a peak power from numerously series-parallel connected several photovoltaic panels, of which an output power changes from moment to moment depending on the weather (solar irradiation), the temperature and so on.

### BACKGROUND ART

Recently, developments of a photovoltaic power generation system using the photovoltaic cell are moving through, and studies for efficiently supplying a direct current (DC) power generated by the photovoltaic cell to a load and an existing power system are generally ongoing.

As a solar cell (SC) that is an electrical generation element of the photovoltaic cell, there are kinds of such as a silicon crystal type photovoltaic cell, an amorphous silicon photovoltaic cell, a compound semi-conductor photovoltaic cell, and an organic semi-conductor photovoltaic cell or the like put to a practical use.

Single body of panel type products for obtaining necessary voltage and current by connecting their photovoltaic cells in numerously series-parallel is so-called a photovoltaic panel or a photovoltaic module (hereinafter, merely referred to as “photovoltaic panel”). A product for obtaining a necessary power by connecting more number of photovoltaic panels in series-parallel is referred to as “photovoltaic array”. FIG. 1 shows a general characteristic example of a current (I)-voltage (V) characteristic curve of a photovoltaic panel.

For efficiently obtaining a peak power from the photovoltaic panel, it is important to operate an actual operating point P “operating current Iₒₚ×operating voltage Vₒₚ” of a photovoltaic panel at a maximum power point Pₘₐₓ “optimal operating current Iₚₘ×optimal operating voltage Vₚₘ” as possible as it can. In conventional photovoltaic power generation systems, a maximum power point tracking (hereinafter, referred to as “MPPT”) control for track-controlling the output voltage and current in such a way that outputs of a photovoltaic panel constantly operate at a maximum power point Pₘₐₓ is generally used, and many methods for the MPPT control are proposed.

Further, as shown in FIGS. 2(A) and 2(B), the output power characteristics of a photovoltaic panel (hereinafter, merely referred to as “panel”) change due to environment conditions such as weather (solar irradiation), ambient temperature and so on. That is, values of an output voltage and an output current at a time that an output power becomes maximum change due to the environment conditions. Therefore, for most effectively using a photovoltaic array, the MPPT function for controlling an output voltage or an output current of a panel in such a way as to constantly output a peak power is necessary.

### [The Problem of the Parallel-Connection System]

In case of connecting plural panels in parallel and connecting them to a voltage source such as a secondary cell, all of generated currents are outputted if currents at maximum power points of respective panels are the same. However, as shown in FIG. 2(A), the output voltages vary up to about 20% at a maximum among panels if there are temperature differences among panels. For accumulating the power of panels, it is necessary to receive all currents of panels. However, the voltage of a voltage source such as a secondary cell has no choice but to operate with the lowermost panel voltage within the parallel-connected panels if a voltage difference due to the temperature difference is generated between parallel-connected panels. In that case, there is a problem that a part of the power is done away without outputting all powers of panels having higher voltages than the lowest one.

### [The Problem of the Series-Connection System]

In case of connecting plural panels in series and connecting to a voltage source such as a secondary cell, all generating currents are outputted if currents at maximum power points of respective panels are the same, because no problem occurs under the same solar irradiation due to the current difference caused by the difference of light quantity. However, as shown in FIG. 2 (B), since the output current drastically changes (maximum of about ten times) due to the difference of light quantity, the current difference at maximum power points occur between panels if only a part of panels enters in the shadow. In a case that the current of panels has differences, a voltage source such as a secondary cell can receive all voltages of panels only when adapted to the lower current so that the bypass diode of a lower current panel does not work. Therefore, the series-connection system is inevitably operated by a current of a panel having the lowest current. In that case, there is a problem that a part of the power is done away without outputting all powers of panels having higher current output capacity than the lowest one.

For coping with the above problems, as a conventional way, there is a known art that uses an MPPT conversion module (power converter) having a fly-back booster circuit in respective panels without looking for a maximum power point by integrating total power of a panel array. An example is shown in FIG. 3. Since this system has a functional role in a direction for increasing the voltage, it can be utilized for increasing the voltage by decreasing the current when the current generating capacity of panels is large. The disadvantage and advantage of this system are as follows:
(1) It is a system for converting the total power and boosting the voltage.
(2) This system is possible to increase the voltage, but impossible to increase the current. In case of connecting respective panels in series, since it has no choice but to be adapted to a panel having a smaller output current as stated above, this system is unsuitable for an array of series-connection. However, there is no problem for a parallel-connection array.

There is another system using a back-down converter (not shown) instead of the fly-back booster circuit. This is a system that decreases the output voltage by a down converter for the total power of a panel array. However, since this system can increase the current greater than a generating current of a panel, it is also applicable for an array of series-connection.

As well, the parallel-connection is also possible by adjusting to an output voltage of a panel having the lowest voltage. However, it is converting the total power as well. Accordingly, there is a problem that a switching loss is increased in a semi-conductor switch. That is, in such two conventional systems, since the total power of a panel array passes through the MPPT conversion module, the power multiplied by the efficiency of the MPPT conversion module becomes a conclusive output and the difference becomes a power loss. Moreover, since the output current becomes an interrupted current, in an environment that a noise becomes a problem, it becomes a problem that an electrolytic capacitor having a high voltage and a large capacity is necessary to suppress a noise.

Further, there are also proposals for making uniform voltages (in case of parallel-connection) or currents (in case of series-connection) of respective panels by performing the MPPT control with respect to respective panels (cf. Patent Documents 1 and 2). However, in this case, it is also performing the total power conversion with respect to each panel, and therefore the loss by the efficiency of the MPPT conversion module is not avoidable.

### THE LIST OF PRIOR ART DOCUMENTS

### Patent Document

Patent Document 1: Japanese Unexamined Patent Publication No. 2011-8348 A
Patent Document 2: Japanese Unexamined Patent Publication No. H08-46231 A

### SUMMARY OF THE INVENTION

### Problems to be solved by the Invention

The present invention has been developed in view of the above-described circumstances, and an object of the present invention is to provide a photovoltaic power generation system that performs the MPPT control with respect to respective panels and minimizes the power loss due to the power conversion.

### Means for Solving the Problems

The present invention relates to a photovoltaic power generation system which generates a DC power at a string composed by connecting plural photovoltaic panels in parallel and said photovoltaic panels, converts said DC power by a power converter connected to said string and supplies it to a load, the above-described object of the present invention is achieved by that said respective photovoltaic panels comprising a voltage detection section for detecting a voltage value generated in said photovoltaic panel and a power detection section for detecting an energy generated in said photovoltaic panel; further comprising power charge sections connected to said photovoltaic panels in series and a maximum power point tracking (MPPT) control section for controlling a voltage value charged by said power charge section; wherein said power charge section comprises a DC power source for power charge, a charge power adjustment section for adjusting a voltage for charging, and a power measurement section for measuring a charged energy; and wherein said MPPT control section controls said respective photovoltaic panels so as to have a voltage at a maximum power point of said respective photovoltaic panels, and controls said charge power adjustment section so that a net output power Wₙₑₜ (W1-W2) which is a difference between an energy (W1) at said maximum power point and a charge energy (W2) measured by said power measurement section becomes maximum.

The present invention also relates to a photovoltaic power generation system which generates a DC power at a string composed by connecting plural photovoltaic panels in series and said photovoltaic panels, converts said DC power by a power converter connected to said string and supplies it to a load, the above-described object of the present invention is achieved by that said respective photovoltaic panels comprising a voltage detection section for detecting a voltage value generated in said photovoltaic panel and a power detection section for detecting an energy generated in said photovoltaic panel; further comprising power charge sections connected to said photovoltaic panels in parallel and a maximum power point tracking (MPPT) control section for controlling a current value charged by said power charge section; wherein said power charge section comprises a DC power source for power charge, a charge power adjustment section for adjusting a current for charging, and a power measurement section for measuring a charged energy; and wherein said MPPT control section controls said respective photovoltaic panels so as to have a voltage at a maximum power point of said respective photovoltaic panels, and controls said charge power adjustment section so that a net output power Wₙₑₜ which is a difference between an energy (W1) at said maximum power point and a charge energy (W2) measured by said power measurement section becomes maximum.

Further, the above-described object of the present invention is achieved by that said MPPT control section controls voltages of said respective photovoltaic panels by controlling said charge power adjustment section with a feedback control so that said net output power Wₙₑₜ which is said difference between said energy (W1) at said maximum power point and said charge energy (W2) measured by said power measurement section becomes maximum.

Furthermore, the above-described object of the present invention is achieved by keeping voltages of said photovoltaic panels with a feedback control so as to have a voltage at a maximum power point constantly by making said charge power adjustment section connected in series be a bootstrap circuit which boosts itself by using a part of currents generated in said photovoltaic panels according to a DC/DC down-converter circuit for generating a low voltage, by using said part of currents generated in said photovoltaic panels instead of said DC power source for power charge.

Still further, the above-described object of the present invention is achieved by that said MPPT control section has functions for detecting, determining and memorizing a voltage as a voltage (Vₘₐₓ) at a maximum power point wherein a net output power Wₙₑₜ becomes maximum, by continuously changing voltages of said photovoltaic panels by controlling said charge power adjustment section, and wherein said net output power Wₙₑₜ is a difference between said output power (W1) from a photovoltaic panel and a charge energy (W2) measured by said power measurement section.

The above-described object of the present invention is also achieved by that said MPPT control section controls, with respect to said respective photovoltaic panels, in such a way as to scan said charge energy (W2) with a time-sharing sequence, to memorize said voltage (Vₘₐₓ) of said photovoltaic panels that a net output power Wₙₑₜ which is a difference between said energy (W1) generated at that time in said photovoltaic panels and said charge energy (W2) becomes maximum, and to keep the voltage (Vₘₐₓ) till a next scanning of the photovoltaic panels.

Further, the above-described object of the present invention is achieved by a photovoltaic power generation system comprises any one of said strings, a photovoltaic array composed by connecting said strings in series or in parallel, and a power conditioner for supplying a power to a load by converting a DC outputted from said string or said photovoltaic array, wherein said power conditioner comprises a maximum power point tracking (MPPT) function, and wherein said MPPT control section does not perform a power charge operation for one or plural photovoltaic panel(s) within said string or said photovoltaic array, and a power decreasing caused by not performing said power charge operation is supplemented by a MPPT function of said power conditioner so that it can avoid both the MPPT control section and the power conditioner charging the power at the same time.

### Effects of the Invention

According to the photovoltaic power generation system of the present invention, the power is, without wastefulness, obtainable if the total output voltages have the same values by charging the lacking voltage of respective panels in parallel-connection, and the peak power is, without wastefulness, obtainable if the total output currents have the same values by charging the lack of current of respective panels in the series-connection.

Further, according to the photovoltaic power generation system of the present invention, since the DC power source for power charge is provided as another power source, it is possible to stably supply the power charge source even if the generated power becomes weak due to a sudden change of the solar irradiation (the light quantity).

Moreover, according to the photovoltaic power generation system of the present invention, it is not necessary to convert the total power because only a lack of current or voltage is charged. Therefore, it is possible to suppress the power loss due to the efficiency of a power converter to a minimum.

### BRIEF DESCRIPTION OF THE DRAWINGS

In the accompanying drawings:

FIG. 1 is a characteristic diagram showing a general characteristic example of current (I)−voltage (V) characteristic curve of a photovoltaic panel;

FIG. 2 is characteristic diagrams showing differences of characteristic curves according to differences of environmental conditions; (A) shows a relationship of an output current and a voltage according to differences of temperatures of panels, and (B) shows a relationship of an output current and a voltage according to differences of light quantities;

FIG. 3 is a schematic diagram showing an example using an MPPT conversion module (power converter) having a conventional fly-back booster circuit;

FIG. 4 is a block configuration diagram showing the first embodiment (voltage charge type) of the photovoltaic power generation system according to the present invention;

FIG. 5 is a block diagram showing a configuration example of the power charge section;

FIG. 6 is a block diagram showing another configuration example of the power charge section;

FIG. 7 is a block configuration diagram showing the second embodiment (current charge type) of the photovoltaic power generation system according to the present invention;

FIG. 8 is a schematic diagram showing a practical example of the photovoltaic panel;

FIG. 9 is a schematic diagram showing a practical example of a mega-solar photovoltaic power generation system;

FIG. 10 is a block configuration diagram showing the third embodiment (voltage charge type) of the photovoltaic power generation system according to the present invention;

and

FIG. 11 is a block configuration diagram showing the fourth embodiment (current charge type) of the photovoltaic power generation system according to the present invention.

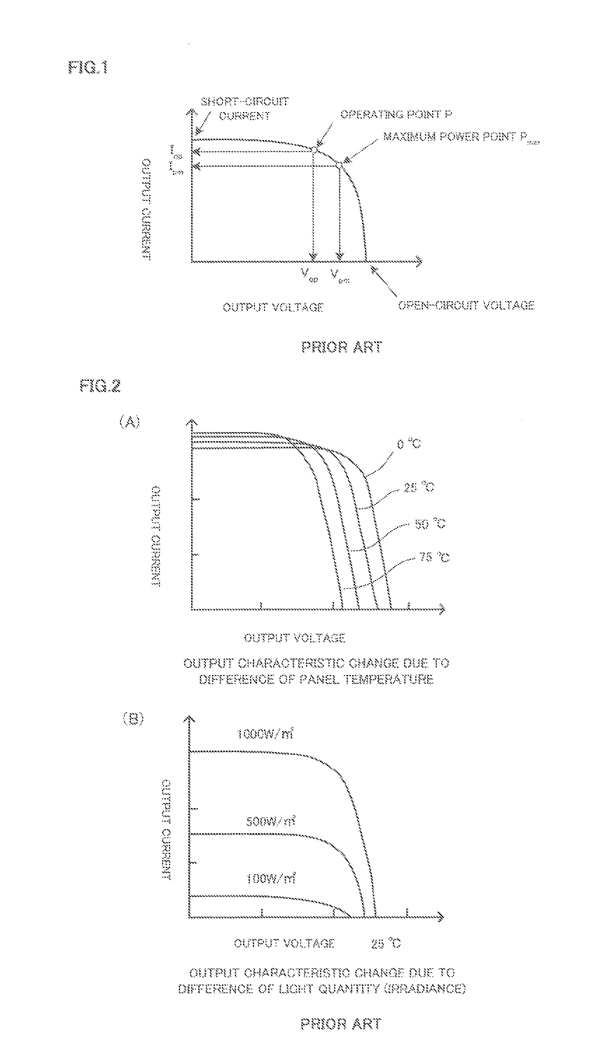

### MODE FOR CARRYING OUT THE INVENTION

Generally, in case that a photovoltaic array is constructed by producing strings by connecting plural panels in parallel or series and further by connecting the strings in parallel or series, a constructing method is used by selecting any one of the followings; 1) combining panels which have the same photovoltaic generation capacities (characteristics), 2) selecting strings which have uniformed currents in a unit of string in case of connecting parallel strings in series, or 3) selecting strings which have uniformed voltages in a unit of string in case of connecting series strings in parallel.

However, even if panels (strings) having the same characteristics are combined as the above way, if only a part of panels enters in the shadow or bird's droppings attach on panels (strings), differences of receiving light amounts are generated among panels and differences of generated currents (powers) are generated. It is the same in the change of photovoltaic power amounts changing in accordance with the change of temperature.

In this case, although the conventional system has increased a reduced voltage by a DC up-converter etc. in a unit of string or array, there is a case that the current cannot be increased even if the voltage can be increased. Also, it is proposed to make a maximum power point in a unit of panel (please refer to Patent documents 1 and 2), but it is the same idea. Furthermore, the problem of the loss in converting the power cannot be ignored.

The present invention is entirely different from such conventional idea, and it is a photovoltaic power generation system that charges only a power (current or voltage) reduced by the change of environment conditions from another power source.

For parallel-connecting of panels, the voltage is charged to adjust to a panel which has the highest generated voltage, and for series-connecting of panels, the current is charged to adjust to a panel which has the highest generated current.

The advantage of a power charge (supplementation) type like the present invention is that a conversion power loss is not generated because charging of voltage or current is not necessary in a case that conditions of all panels (environment conditions) are the same and there is no difference of voltage or current at a maximum power point. In a case that a few panels are shifted from other large number of panels, it is enough to charge the voltage is charged in parallel-connection and the current in series-connection only for the shifted panels.

Hereinafter, the present invention will now be explained in more detail with referring to figures illustrated in the drawings.

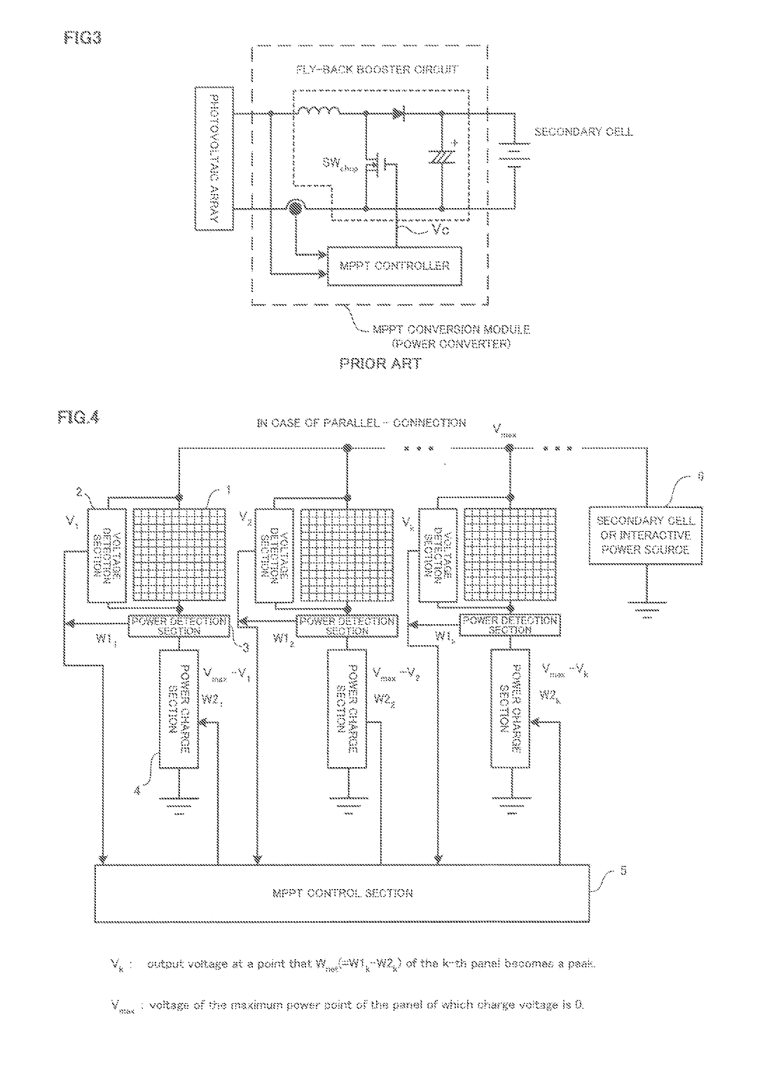

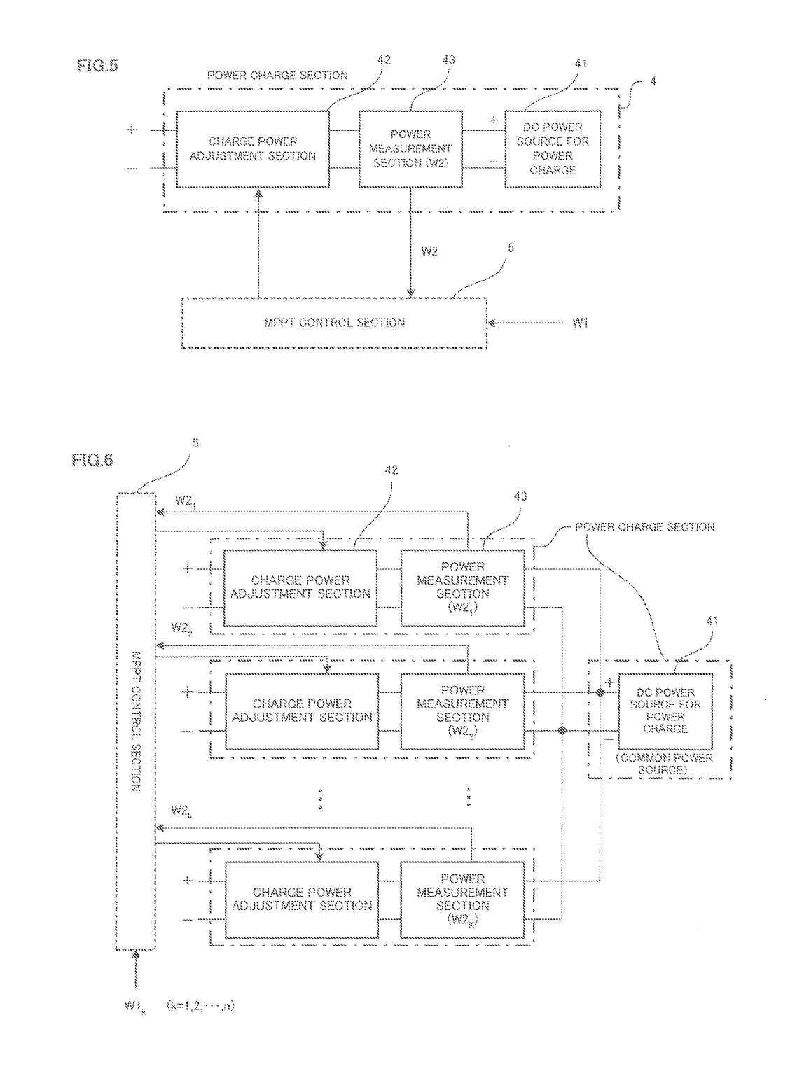

FIG. 4 is a block configuration diagram showing the first embodiment of a photovoltaic power generation system according to the present invention. That is, a string is formed by connecting plural panels 1 in parallel, and power charge sections 4 are respectively inserted in series between output sides (minus sides) of the respective panels 1 and the ground (common). Input sides (plus sides) of the respective panels 1 are connected to a plus side of a load 6 such as a secondary power source or an interactive power source.

Moreover, voltage detection sections 2 for detecting operating voltage (V) of the respective panels 1 and power detection sections 3 for detecting energy (W1) outputted from the panels 1 are provided with respect to the respective panels 1. As well, the current detection sections may as well be provided instead of the power detection sections 3. The reason is that the power (energy) can be obtained from “voltage X current”.

Furthermore, a maximum power point tracking control section (hereinafter, referred to as “MPPT control section”) 5 is provided, and controls a voltage for charging based on the detected voltage (V) of the panel 1, the energy (W1) and an after-mentioned charged energy (W2).

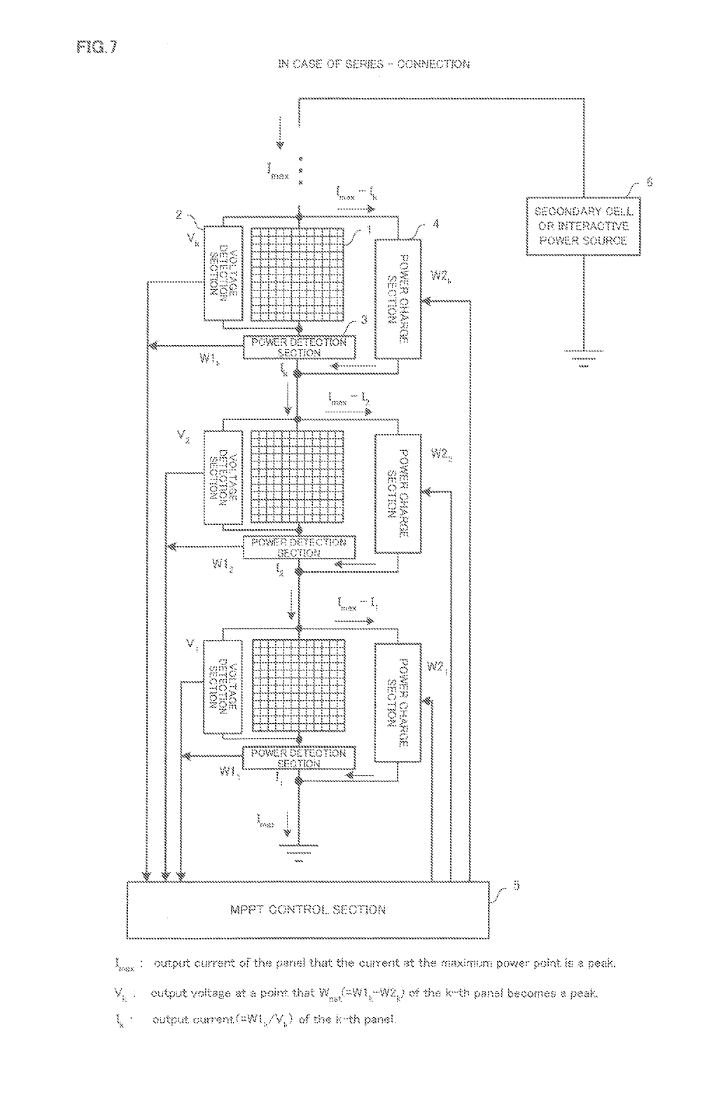

FIG. 5 is a block diagram showing a configuration example of the power charge section 4, and the power charge section 4 includes a DC power source 41 for power charge, a charge power adjustment section 42 for adjusting the charged power and a power measurement section 43 for measuring the energy (W2) charged in series into the panel 1.

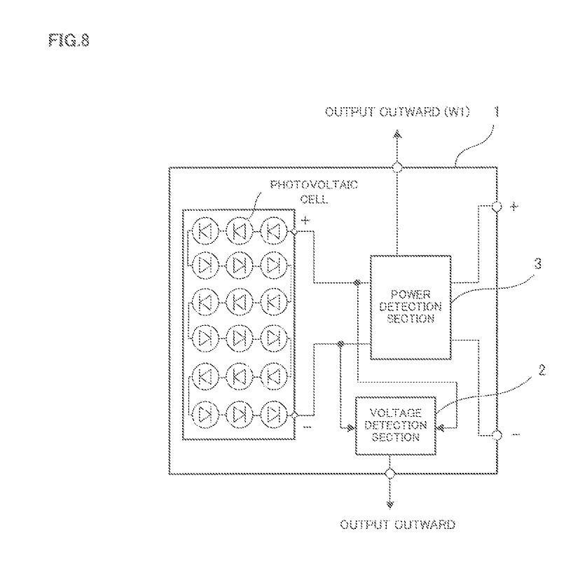

As well, although the DC power source 41 for power charge may be provided with each of the panels 1, as shown in FIG. 6, it may be provided with each of strings or may be also provided one commonly with a photovoltaic array configured by connecting the strings in parallel or series. In this case, by performing an insulation of the input side or the output side according to the necessity, a problem of a grounding system is avoided. As the charge power adjustment section 42, for example, a DC/DC up- or down-converter may be used. Moreover, a power conditioner that is an apparatus to convert a generated electricity for using in domestic environment may be connected.

In the above-mentioned configuration, the operation of the photovoltaic power generation system according to the present invention will now be explained in more detail with referring to FIG. 4.

Now, in a string configured by connecting plural panels 1 in parallel, a largest voltage at a maximum power point is assumed “Vₘₐₓ”. Since voltages (so-called “Vₖ”) of other panels are smaller than the maximum voltage value “Vₘₐₓ”, unless charging voltage of differences by the power charge section 4, the voltage of this string is operated by the voltage with a panel which has the minimum voltage at the maximum power point.

In this connection, the MPPT control section 5 charges the voltage by feedback-controlling the charge power adjustment section 42 in such a way that a difference between a detected energy W1ₖ and an energy W2ₖ, i.e. a net output power Wₙₑₜ (=W1ₖ−W2ₖ) becomes maximum. As a result, at a point that the energy Wₙₑₜ is maximum, the voltage of the panel 1 is a voltage Vₖ (the energy W1ₖ is maximum at this time) of the maximum power point, wherein the charged voltage becomes “Vₘₐₓ−Vₖ” (the energy W2ₖ is minimum at this time) as a result, and accordingly, only a voltage of differences is charged. Needless to say, the voltage is not charged in the panel having the maximum voltage at the maximum power point. The reason is that: if “Vₖ=Vₘₐₓ”, then “Vₘₐₓ−Vₘₐₓ=0”.

By performing this way, even if only a particular panel enters in the shadow and the voltage decreases, optimal voltage charges are performed to the panels and the string as a whole is operated with a constant voltage.

Although the feedback control of the charge voltage is performed in the charge power adjustment section 42 in the power charge section 4, the feedback control method may be performed by a method such as a voltage control with a triangle-wave comparing PWM, a control with PDM (Pulse Density Modulation) for controlling a pulse frequency (density), or any other methods. The advantage of controlling the panel voltage by feedback control is that the panel voltage does not fluctuate even if the voltage of a secondary cell or other interactive power source fluctuates. In a case that a secondary cell is lithium-ion cell, the change of the power source side due to a load change, such as increasing of the voltage by charging and so on, becomes larger. However, such influence is insusceptible in the present invention.

Further, since the charging of a string connected in the parallel is a low voltage, by using a part of a current generated in the panel 1 instead of the DC power source 41 for power charge, it is also possible to make the charge power adjustment section 42 as so-called bootstrap circuit (it boosts the output voltage thereof with the power thereof) with a DC/DC down-converter circuit for generating a low voltage, and as well always to keep the voltage of the panel 1 with the feedback control so as to have constantly the voltage at the maximum power point.

Moreover, if the DC/DC up- or down-converter as the charge power adjustment section 42 of the power charge section 4 is a type of outputting the power via an isolation transformer, the same effect is obtained even if a voltage is added to any place of the series-connection with the panel 1. Accordingly, it is possible to insert the power charge section 4 into an area away from the ground, and the flexibility in designing is enhanced.

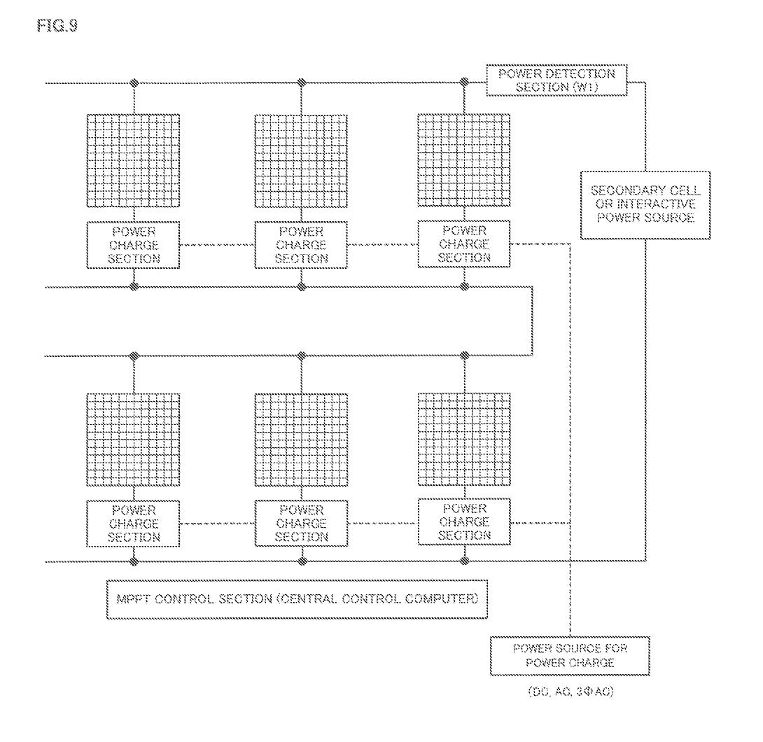

FIG. 7 is a block configuration diagram showing the second embodiment of the photovoltaic power generation system according to the present invention. That is, strings are formed by connecting plural panels 1 in series, and power charge sections 4 are respectively inserted in parallel between output side (minus side) of the respective panels 1 and the ground (common). Each input side (plus side) of the respective panels 1 is connected to a load 6 such as a secondary cell, an interactive power source or the like.

Moreover, voltage detection sections 2 for detecting the operating voltage (V) of the respective panels 1 and power detection sections 3 for detecting the electric energy (W1) outputted from the panels 1 are provided to the respective panels 1.

Furthermore, an MPPT control section 5 is provided, and controls the currents for charging based on the detected voltage V of the panels, the energy W1 and the charge energy W2.

In the above-mentioned configuration, the operation of the second embodiment of the photovoltaic power generation system according to the present invention will now be explained in more detail with referring to FIG. 7.

As shown in FIG. 7, a maximum current at a maximum power point is assumed “Iₘₐₓ” among the strings made by connecting plural panels 1 in series. Currents (Iₖ) of other panels 1 are smaller than the maximum current value Iₘₐₓ, and therefore, unless charging currents of differences by the power charge section 4, the current of the string is operated with a minimum panel current at the maximum power point.

Accordingly, the MPPT control section 5 charges the current to the panels 1 by feedback-controlling the charge power adjustment section 42 in such a way that the difference between a detected energy W1ₖ and an energy W2ₖ, i.e. a net output power Wₙₑₜ becomes maximum. As a result, at a point where the energy Wₙₑₜ becomes maximum, a voltage of the panel 1 is the maximum power point becomes a voltage Vₖ (the energy W1ₖ is maximum at this time), a charged current is accordingly “Iₘₐₓ−Iₖ” (the energy W2ₖ is minimum at this time) as a result, and therefore, only a current of differences is charged. Needless to say, a current is not charged in a panel having a maximum current at the maximum power point. The reason is that: if “Iₖ=Iₘₐₓ”, then “Iₘₐₓ−Iₘₐₓ=0”.

By performing this way, even if only a particular panel enters in the shadow and the current decreases, optimal current charges are performed to the panels, and the string as a whole is operated with a constant current.

As the above MPPT control section, a microcomputer, a personal computer can be used, or a superior computer performing a central administration may be used for a mega-solar.

FIG. 8 shows another embodiment of a panel used for the photovoltaic power generation system according to the present invention, and the panel 1 has a voltage detection section 2 and a power detection section 3 built-in.

The power charge section of the present invention is not a conventional total power conversion type such as a fly-back booster circuit or a back-down depressor circuit, but a type that the lack of current is charged by connecting it to panels in series and the lack of current by connecting it to panels. That is, the power charge section of the present invention is a type not converting a total power but charging a low voltage source. A down-converter power source with a low voltage has a small loss. For example, in a case that there is a difference of 10% of voltage among voltages at maximum power points of respective panels, assuming that the efficiency of a converter is 90%, even if a conventional boost type converter corrects the voltage by increasing the voltage, 10% becomes a loss. Accordingly, the total power does not increase by such conversion, and the correcting thereby is meaningless.

The present invention charges only a lack of power, and has a loss of 10% of 10%, i.e. only 1% becomes a loss, while the power increases 9% larger than conventional methods.

Moreover, an electrolytic capacitor for a filter of an output current is mounted to a low voltage part because a voltage to be charged is low. Therefore, it is possible to use a small capacitor having a lower withstand voltage than the conventional type.

In a large scale photovoltaic power generation, the greater the power for operation is handled, the more it becomes advantageous in the points of the cost of converter and the efficiency, and therefore, it is predominate to connect panels numerously in parallel. However, the change is small because a voltage is charged only a difference caused by such as the temperature difference and so on. Therefore, in a case of constructing an array by connecting numerous panels, first a string is formed by connecting panels in parallel, and then, an array is formed by connecting a plural number of the above string in series. As a constructive example of an array, as shown in FIG. 9, it is explained by showing an example with two-stage of strings connected in series.

In a case of a voltage charge-type MPPT (i.e. a case of a parallel-connected string), since it is possible to transmit a maximum power by adding a current to a string having a lower current, it is possible to first decide a string having a small current within the strings connected in parallel in FIG. 9. Although the MPPT scanning is performed respectively in each panel by time-sharing so that a maximum power is obtained in the whole system, it is possible to check increasing or decreasing of a measuring power in the whole or a part or group by increasing or decreasing the voltage Vi of charged powers of respective panels.

In the practical example of a mega-solar photovoltaic power generation system in FIG. 9, the dotted lines have roles as showing a power line from a power source for power charge to the power charge section and as a transmission line (not shown) for transmitting a charge power command Vi from a central control computer to respective power charge sections. Also, the central control computer has functions that measures a total power Wₜₒₜₐₗ of the whole photovoltaic panels and obtains a maximum power point based on a relationship with the respective generated voltages Vi.

Moreover, the power source line is also possible in either DC, AC or three-phase (3Φ) AC. Although there may have a better constitution having no problem of the ground potential by isolating a power source, it is necessary to consider the balance with that the efficiency goes down. The supplying line of a power-source power is rational if it is also used as a communication network of PLC (Power Line Communication) for communicating with a central control computer.

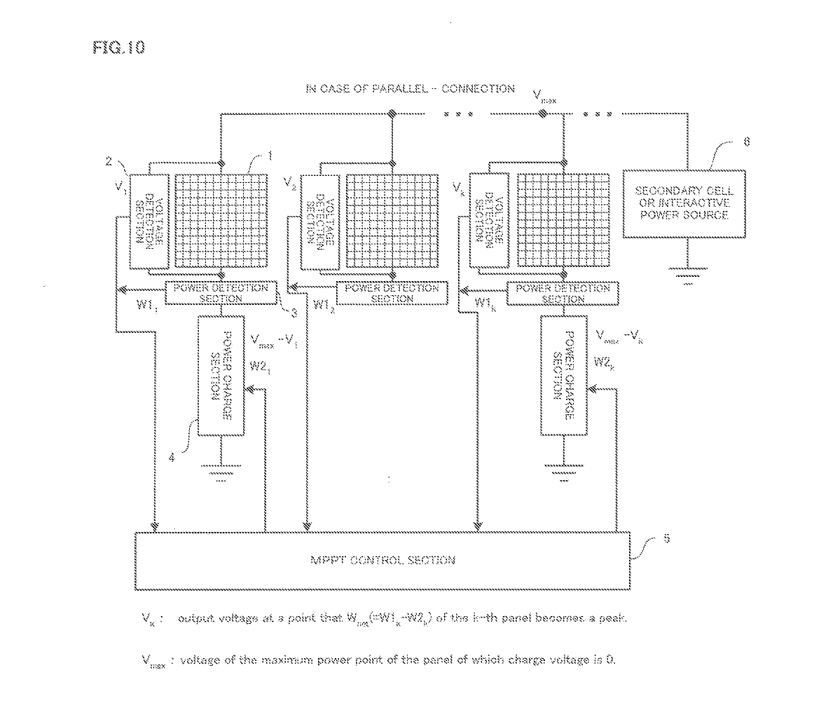

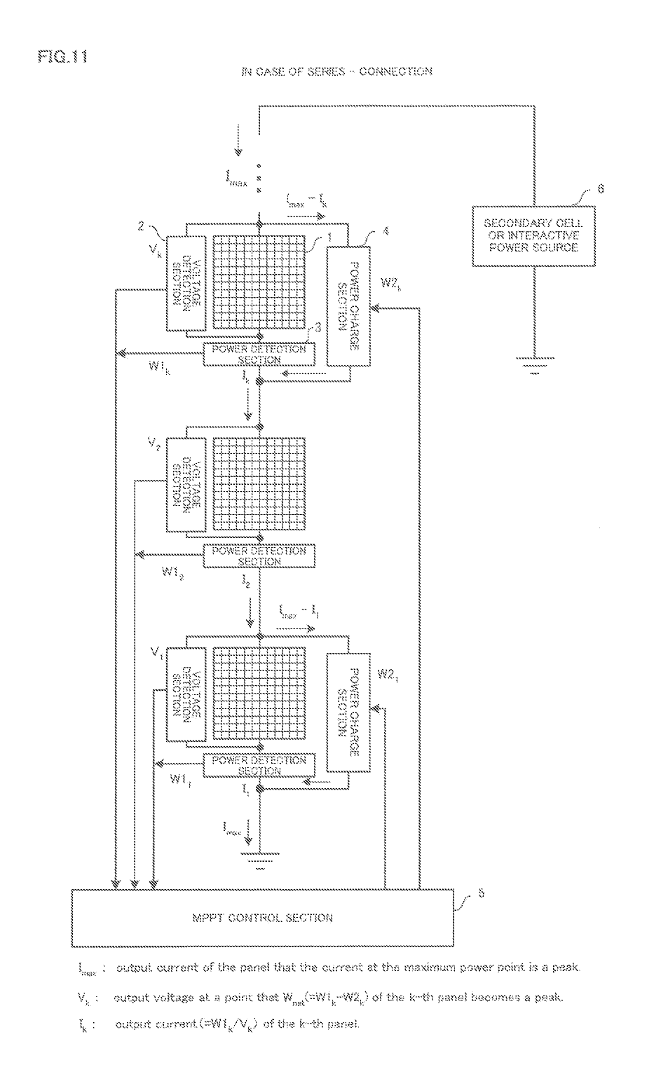

Further, although the above respective embodiments show that the power charge sections 4 are connected to all panels 1, the power charge section 4 may not as well be connected to a voluntary panel or voluntary plural panels as shown in FIG. 10 (a voltage charge type corresponding to FIG. 4) or FIG. 11 (a current charge type corresponding to FIG. 7). In a case of plural panels, it may possible to provide a distance without the power charge section 4 per one piece, per plural pieces, or per voluntary pieces. In such the case not connecting the power charge section 4, the power decreasing caused by not connecting the power charge section 4 to a panel is charged by the maximum power point tracking (MPPT) function of the power conditioner, so as to avoid both the power charge section 4 and the power conditioner operate at the same time.

### EXPLANATION OF REFERENCE NUMERALS

1 photovoltaic panel
2 voltage detection section
3 power detection section
4 power charge section
41 DC power source for power charge
42 charge power adjustment section
43 power measurement section
5 MPPT control section
6 load of a secondary cell, an interactive power source, etc.

1.-13. (canceled)

14. A photovoltaic power generation system which generates a DC power at a string composed by connecting plural photovoltaic panels in parallel and said photovoltaic panels, converts said DC power by a power converter connected to said string and supplies it to a load, wherein:
said respective photovoltaic panels comprising a voltage detection section for detecting a voltage value generated in said photovoltaic panel and a power detection section for detecting an energy generated in said photovoltaic panel;
further comprising power charge sections connected to said photovoltaic panels in series and a maximum power point tracking (MPPT) control section for controlling a voltage value charged by said power charge section;
wherein said power charge section comprises a DC power source for power charge, a charge power adjustment section for adjusting a voltage for charging, and a power measurement section for measuring a charged energy; and
wherein said MPPT control section controls said respective photovoltaic panels so as to have a voltage at a maximum power point of said respective photovoltaic panels, and controls said charge power adjustment section so that a net output power Wₙₑₜ (W1−W2) which is a difference between an energy (W1) at said maximum power point and a charge energy (W2) measured by said power measurement section becomes maximum.

15. The photovoltaic power generation system according to claim 14, wherein said MPPT control section controls voltages of said respective photovoltaic panels by controlling said charge power adjustment section with a feedback control so that said net output power Wₙₑₜ which is said difference between said energy (W1) at said maximum power point and said charge energy (W2) measured by said power measurement section becomes maximum.

16. The photovoltaic power generation system according claim 14, wherein said DC power source for charge power is provided one in said respective power charge section in common.

17. The photovoltaic power generation system according to claim 14, wherein said charge power adjustment section includes a DC/DC up- or down-converter circuit.

18. The photovoltaic power generation system according to claim 17, wherein said DC/DC up- or down-converter circuit includes an isolation transformer.

19. The photovoltaic power generation system according to claim 14, wherein keeping voltages of said photovoltaic panels with a feedback control so as to have a voltage at a maximum power point constantly by making said charge power adjustment section connected in series be a bootstrap circuit which boosts itself by using a part of current generated in said photovoltaic panel according to a DC/DC down-converter circuit for generating a low voltage, by using said part of currents generated in said photovoltaic panels instead of said DC power source for power charge.

20. The photovoltaic power generation system according to claim 14, wherein said MPPT control section has functions for detecting, determining and memorizing a voltage as a voltage (Vₘₐₓ) at a maximum power point wherein a net output power Wₙₑₜ is maximum, by continuously changing voltages of said photovoltaic panels by controlling said charge power adjustment section, and
wherein said net output power Wₙₑₜ is a difference between said output power (W1) from the photovoltaic panel and a charge energy (W2) measured by said power measurement section.

21. The photovoltaic power generation system according to claim 14, wherein said MPPT control section controls, with respect to said respective photovoltaic panels, in such a way as to scan said charge energy (W2) with a time-sharing sequence, to memorize said voltage (Vₘₐₓ) of said photovoltaic panels that a net output power Wₙₑₜ which is a difference between said energy (W1) generated at that time in said photovoltaic panels and said charge energy (W2) becomes maximum, and to keep the voltage (Vₘₐₓ) till a next scanning of the photovoltaic panels.

22. The photovoltaic power generation system according to claim 14, wherein said power detection section and said voltage detection section are built in said photovoltaic panel.

23. The photovoltaic power generation system, wherein having a photovoltaic array connected said plural strings claimed in claim 14 in series.

24. The photovoltaic power generation system, comprising said string claimed in claim 14, or a photovoltaic array composed by connecting said strings in series or parallel, and a power conditioner for supplying a power to a load by converting a DC output from said string or said photovoltaic array,
wherein said power conditioner comprises a maximum power point tracking (MPPT) section, and wherein said MPPT control section does not perform a power charge operation for one or plural photovoltaic panel(s) within said string or said photovoltaic array, and a power decreasing caused by not performing said power charge operation is supplemented by a MPPT function of said power conditioner.

25. A photovoltaic power generation system which generates a DC power at a string composed by connecting plural photovoltaic panels in series and said photovoltaic panels, converts said DC power by a power converter connected to said string and supplies it to a load, wherein:
said respective photovoltaic panels comprising a voltage detection section for detecting a voltage value generated at said photovoltaic panel and a power detection section for detecting an energy generated in said photovoltaic panel;
further comprising power charge sections connected to said photovoltaic panels in parallel and a maximum power point tracking (MPPT) control section for controlling a current value charged by said power charge section;
wherein said power charge section comprises a DC power source for power charge, a charge power adjustment section for adjusting a current for charging, and a power measurement section for measuring a charged energy; and
wherein said MPPT control section controls said respective photovoltaic panels so as to have a voltage at a maximum power point of said respective photovoltaic panels, and controls said charge power adjustment section such that a net output power Wₙₑₜ (W1−W2) which is a difference between an energy (W1) at said maximum power point and a charge energy (W2) measured by said power measurement section becomes maximum.

26. The photovoltaic power generation system according to claim 25, wherein said MPPT control section controls voltages of said respective photovoltaic panels by controlling said charge power adjustment section with a feedback control so that said net output power Wₙₑₜ which is said difference between said energy (W1) at said maximum power point and said charge energy (W2) measured by said power measurement section becomes maximum.

27. The photovoltaic power generation system according to claim 25, wherein said DC power source for charge power is provided one in said respective power charge section in common.

28. The photovoltaic power generation system according to claim 25, wherein said charge power adjustment section includes a DC/DC up- or down-converter circuit.

29. The photovoltaic power generation system according to claim 28, wherein said DC/DC up- or down-converter circuit includes an isolation transformer.

30. The photovoltaic power generation system according to claim 25, wherein said MPPT control section has functions for detecting, determining and memorizing a voltage as a voltage (Vₘₐₓ) at a maximum power point wherein a net output power Wₙₑₜ is maximum, by continuously changing voltages of said photovoltaic panels by controlling said charge power adjustment section, and
wherein said net output power Wₙₑₜ is a difference between said output power (W1) from a photovoltaic panel and a charge energy (W2) measured by said power measurement section.

31. The photovoltaic power generation system according to claim 25, wherein said MPPT control section controls, with respect to said respective photovoltaic panels, in such a way as to scan said charge energy (W2) with a time-sharing sequence, to memorize said voltage (Vₘₐₓ) of said photovoltaic panels that a net output power Wₙₑₜ which is a difference between said energy (W1) generated at that time in said photovoltaic panels and said charge energy (W2) becomes maximum, and to keep the voltage (Vₘₐₓ) till a next scanning of the photovoltaic panels.

32. The photovoltaic power generation system according to claim 25, wherein said power detection section and said voltage detection section are built in said photovoltaic panel.

33. The photovoltaic power generation system, wherein having a photovoltaic array connected said plural strings claimed in claim 25 in parallel.

34. The photovoltaic power generation system, comprising said string claimed in claim 25, or a photovoltaic array composed by connecting said strings in series or parallel, and a power conditioner for supplying a power to a load by converting a DC output from said string or said photovoltaic array,
wherein said power conditioner comprises a maximum power point tracking (MPPT) section, and wherein said MPPT control section does not perform a power charge operation for one or plural photovoltaic panel(s) within said string or said photovoltaic array, and a power decreasing caused by not performing said power charge operation is supplemented by a MPPT function of said power conditioner.
